(19) United States
(12) Patent Application Publication
(10) Pub. No.: US 2018/0189720 A1
(43) Pub. Date: Jul. 5, 2018

(54) EVENT DETECTION SYSTEM AND METHOD FOR REAL-TIME INVENTORY MANAGEMENT SYSTEM

(71) Applicant: InventoryTech Limited, Sydenham (NZ)

(72) Inventors: Lance Harry Henderson, Strowan (NZ); Logan Alexander Stephens, Ilam (NZ); Peter James Montgomery, Ohoka RD2 (NZ)

(21) Appl. No.: 15/573,744

(22) PCT Filed: May 13, 2016
(86) PCT No.: PCT/IB2016/052757

§ 371 Date: Nov. 13, 2017

(30) Foreign Application Priority Data
May 14, 2015 (NZ) 708152

(51) Int. Cl. G06Q 10/08; G06F 9/54

(52) U.S. Cl. CPC G06Q 10/087; G06F 9/542

(57) ABSTRACT

A method and system of detecting events and updating inventory data in an inventory management system. The system is configured to sense and monitor inventory levels at one or more inventory locations, each having a load sensor that is configured to sense the weight of inventory items at the inventory location and generate a representative sensor signal. The system receives a digital signal having data samples that represent the sensor signal and moves those through a data buffer. The system generates a moving gradient value representing an average gradient from a moving gradient window applied to at least some of the data samples in the data buffer and compares the generated moving gradient value to one or more thresholds to detect the start and end of events. The system then generates output event data comprising at least weight data representing the inventory level following the detected event.

### FIELD OF THE INVENTION

This invention relates to event detection system and method. In particular, although not exclusively, the event detection system and method may be implemented in a real-time inventory management system.

### BACKGROUND TO THE INVENTION

Event detection systems and methods are employed in various applications. Typically, event detection systems receive a raw signal, for example from a sensor or number of sensors of the same or different types, and process those raw sensor signals to detect or determine when events have occurred. Based on such event detection, further signal processing may then be initiated or triggered to analyse the raw sensor signals, depending on the application.

The difficulty in event detection is that the raw sensor signals, especially when low cost sensors are employed, tend to suffer from drift and/or noise, and can have highly variable properties, parameters and/or behaviours. For example, sensors can drift for a number of reasons, including environmental conditions such as temperature fluctuations, and noise can occur due to interactions or external factors that are not true events but which are nonetheless detected by the sensor and create a spike in the signal which may masquerade as an event.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

It is an object of the invention to provide improved real-time inventory management systems and/or event detection systems and methods for real-time inventory management systems, or to at least to provide the public with a useful choice.

In a first aspect, the invention broadly consists in a method of detecting events and updating inventory data in an inventory management system that is configured to sense and monitor inventory levels at one or more inventory locations, each inventory location comprising a load sensor that is configured to sense the weight of inventory items at the inventory location and generate a representative sensor signal, the method being executed by a data processor or processors and for an inventory location the method comprising: receiving a digital signal comprising data samples that represent the sensor signal generated by the load sensor; moving the data samples of the digital signal through a data buffer; generating a moving gradient value representing an average gradient from a moving gradient window applied to at least some of the data samples in the data buffer; comparing the generated moving gradient value to one or more thresholds to detect the start and end of events, the events representing an interaction with the inventory location in which the inventory level changes; and generating output event data representing the detected event, the output event data at least comprising weight data representing the inventory level following the detected event for updating the inventory data associated with that inventory location.

In an embodiment, the data buffer for an inventory location is a circular data buffer.

In an embodiment, the data buffer for an inventory location is a first-in first-out (FIFO) data buffer.

In an embodiment, the method for an inventory location comprises generating a new moving gradient value for each new data sample moved into the data buffer.

In an embodiment, the moving gradient window for an inventory location generates the moving gradient value by calculating the average of the difference between adjacent data samples within the moving gradient window of the data buffer.

In an embodiment, the moving gradient value is the average gradient represented by the sum of the different values between adjacent data samples within the moving gradient window of the data buffer divided by the number of difference values calculated within the moving gradient window.

In an embodiment, the moving gradient value is calculated from a uniformly spaced sub-sample of the data samples in the moving gradient window, the sub-sample being at least every 2^{nd} data sample or a lower frequency, and wherein the moving gradient value is the average gradient represented by the sum of the difference values between adjacent data samples within the sub-sample divided by the number of difference values calculated for the sub-sample.

In an embodiment, the moving gradient value is the absolute value of the average gradient.

In an embodiment, the method comprises comparing the moving gradient value to an event start threshold to detect the start of an event, and then comparing the subsequently generated moving gradient values to an event end threshold to detect the end of the event.

In an embodiment, the digital signal is sampled from the sensor signal of the load sensor at a sampling frequency, and the moving gradient value is compared to the event start and end thresholds at the same sampling frequency such that the moving gradient value is compared to the thresholds for each new data sample in the data buffer.

In an embodiment, the digital signal is sampled from the sensor signal of the load sensor at a sampling frequency, and the moving gradient value is compared to the event start and end thresholds at a lower frequency than the sampling frequency, such as every n^{th} data sample, where n≥2.

In an embodiment, the method comprises detecting the end of the event once the moving gradient value equals or drops below the event end threshold.

In an embodiment, the end of the event is detected once the moving gradient value equals or drops below the event end threshold for a predetermined time period.

In an embodiment, the method comprises storing the time or data sample number associated with the data samples within the data buffer upon detection of the event.

In an embodiment, the method comprises generating and storing an event start time and an event end time representing the start and end of a detected event.

In an embodiment, the method comprises generating output event comprising an event start value that represents the weight of the inventory items at the inventory location at or associated with the start of the event, and an event end value that represents the weight of the inventory items at the inventory location at or associated with the end of the event.

In an embodiment, the method further comprises generating a moving baseline value representing a rolling or moving average of the digital signal within a moving baseline window applied to the data buffer.

In an embodiment, the method comprises generating the event start value based on the moving baseline value generated by the moving baseline window at the time the moving gradient value is equal to or exceeds an event start threshold.

In an embodiment, the method comprises generating the event end value based on the moving baseline value generated by the moving baseline window at the end of the event.

In an embodiment, the method comprises generating the event end value based on the moving baseline average generated by the moving baseline window once it contains the data samples from the moving gradient window at the time when the moving gradient value equaled an event end threshold.

In an embodiment, the output event data comprises the event start value and event end value. In another embodiment, the output event data comprises at least the event end value.

In an embodiment, the output event data further comprises the event start time and event end time representing the start and end of the detected event.

In an embodiment, the moving gradient window and moving baseline window are applied to a subset of the data samples within the data buffer.

In an embodiment, the method comprises applying the moving gradient window to incoming data samples of the data buffer first, followed by the moving baseline window.

In an embodiment, the method comprises generating output event data that comprises data representing the change in inventory items in the inventory location from the detected event.

In an embodiment, the method further comprises calculating a numerical inventory level for the inventory location based on the weight data in the output event data and data indicative of the inventory unit weight value of a single unit of the type of inventory stored in the inventory location.

In an embodiment, the method further comprises receiving calibration data from a calibration process and updating or adjusting the inventory unit weight value based on the calibration data to increase accuracy of the calculated numerical inventory level.

In an embodiment, the calibration process comprises displaying the current calculated inventory level to a user of the system following a detected event, receiving adjustment data indicative of any error in the displayed inventory level based on user observation of the actual inventory level, and calculating or determining an adjusted inventory unit weight value based on the adjustment data and the weight data associated with the detected event.

In an embodiment, the calibration process comprises displaying the current calculated inventory level on a display at the inventory location, and receiving any adjustment data via an operable user interface at the inventory location.

In an embodiment, the calibration process is operable via a graphical user interface (GUI) of the inventory management system that is accessible by a user via a user electronic device having a display, the GUI displaying the current calculated inventory level associated with the inventory location and displaying an operable user interface to enable the user to provide adjustment data.

In an embodiment, the method is applied in parallel to each respective inventory location being monitored in the inventory management system.

In a second aspect, the invention broadly consists in a computer-readable medium having stored thereon computer executable instructions that, when executed on a processing device, cause the processing device to perform a method of the first aspect of the invention.

In a third aspect, the invention broadly consists in an inventory management system for detecting events and updating inventory data, the system configured to sense and monitor inventory levels at one or more inventory locations, each inventory location comprising a load sensor that is configured to sense the weight of inventory items at the inventory location and generate a representative sensor signal, the system comprising: a processor or processors, and for each respective inventory location the processor or processors being configured to: receive a digital signal comprising data samples that represent the sensor signal generated by the load sensor; move the data samples of the digital signal through a data buffer; generate a moving gradient value representing an average gradient from a moving gradient window applied to at least some of the data samples in the data buffer; compare the generated moving gradient value to one or more thresholds to detect the start and end of events, the events representing an interaction with the inventory location in which the inventory level changes; and generate output event data representing the detected event, the output event data at least comprising the weight data representing the inventory level following the detected event for updating the inventory data associated with that inventory location.

The second and third aspects of the invention may have any one or more of the features mentioned in respect of the first aspect of the invention above.

A fourth aspect disclosed is a method of detecting events comprising: receiving a digital signal comprising data samples; moving the data samples of the digital signal through a data buffer; generating a moving gradient value representing an average gradient from a moving gradient window applied to at least some of the data samples in the data buffer; and comparing the generated moving gradient value to one or more thresholds to detect the start and end of events.

In an embodiment, the data buffer is a circular data buffer. In one form, the data buffer is a first-in first-out (FIFO) data buffer.

In an embodiment, the method comprises generating a new moving gradient value for each new data sample moved into the data buffer.

In an embodiment, the moving gradient window generates the moving gradient value by calculating the average of the difference between adjacent data samples within the moving gradient window of the data buffer. In one example, the moving gradient value is the average gradient represented by the sum of the different values between adjacent data samples within the moving gradient window of the data buffer divided by the number of difference values calculated within the moving gradient window. In an embodiment, the moving gradient value is the absolute value of the average gradient.

In an embodiment, the method comprises comparing the moving gradient value to an event start threshold to detect the start of an event, and then comparing the subsequently generated moving gradient values to an event end threshold to detect the end of the event. In one embodiment, the event start and event end thresholds may be predetermined and fixed values. In an alternative embodiment, the event start and event end thresholds do not need to be predetermined, but may be actively or dynamically determined and updated.

In an embodiment, the method comprises detecting the end of the event by comparing the generated moving gradient values to the event end threshold. In one configuration, the end of the event is detected once the moving gradient value equals or drops below the event end threshold. In another configuration, the end of the event is detected once the moving gradient value equals or drops below the event end threshold for a predetermined time period.

In an embodiment, the method comprises storing the time or sample number associated with the data samples within the data buffer upon detection of the event. In one example, the method comprises generating and storing an event start time and an event end time representing the start and end of a detected event.

In an embodiment, the method further comprises generating a moving baseline value representing a rolling or moving average of the digital signal within a moving baseline window applied to the data buffer.

In an embodiment, the method comprises generating output event data representing the detected event. In one example, the output event data comprises an event start value at or associated with the start of the event, and an event end value at or associated with the end of the event.

In an embodiment, the event start value is the moving baseline value generated by the moving baseline window at the time the moving gradient value is equal to or exceeds the event start threshold.

In an embodiment, the event end value is the moving baseline value generated by the moving baseline window at the end of the event. In one example, the event end value is the moving baseline average generated by the moving baseline window once it contains the data samples from the moving gradient window at the time when the moving gradient value equaled the event end threshold.

In one example, the output event data comprises the event start value and event end value. In one configuration, the output event data further comprises the event start time and event end time.

In one configuration, the moving gradient window and moving baseline window are applied to a subset of the data samples within the data buffer. For example, the windows may each be shorter in length than the data buffer.

In one configuration, the method comprises applying the moving gradient window to incoming data samples of the data buffer first, followed by the moving baseline window. In one configuration, the moving baseline window follows the moving gradient window. In one example, the moving baseline window may immediately follow the moving gradient window. In another configuration, the moving baseline window and the moving gradient window may overlap.

In an embodiment, the digital signal is sampled from a raw analogue sensor signal at a sampling frequency. In one configuration, the moving gradient value is compared to the event start and end thresholds at the sampling frequency such that the moving gradient value is compared to the thresholds for each new data sample in the data buffer. In another configuration, the moving gradient value may be compared to the event start and end thresholds at a lower frequency than the sampling frequency, such as every n^{th} data sample, where n≥2.

In an embodiment, the digital signal represents a sensor signal or a digital sample of a sensor signal.

In an embodiment, the sensor signal is generated by a load sensor configured to sense the weight of inventory items in an inventory location.

In an embodiment, the output event data comprises event start values and event end values that represent the weight of inventory in an inventory location at the start and end of an event.

In an embodiment, the event represents an interaction with the inventory location. The interaction may comprise a removal of inventory items from the inventory location, or a re-stocking of inventory items into the inventory location.

In an embodiment, the output event data comprises data representing the change in inventory items in the inventory location from a detected event. In an embodiment, the output event data may comprise data representing an increase, decrease, or no change in inventory items, and optionally an associated quantifying value, which may be an integer or weight value representing the number or weight of items removed from the inventory location during the detected event or the number or weight of items inserted into the inventory location during the detected event.

In an embodiment, the output event data comprises data representing the real-time inventory level (e.g. weight or number of items) within the inventory location.

A fifth aspect disclosed is a computer-readable medium having stored thereon computer executable instructions that, when executed on a processing device, cause the processing device to perform the method of the fourth aspect.

A sixth aspect disclosed is an event detection system comprising: a processor configured to: receive a digital signal comprising data samples; move the data samples of the digital signal through a data buffer; generate a moving gradient value representing an average gradient from a moving gradient window applied to at least some of the data samples in the data buffer; and compare the generated moving gradient value to one or more thresholds to detect the start and end of events.

In an embodiment, the system further comprises a sensor that is configured to generate a sensor signal, and wherein the digital signal received by the processor represents the sensor signal.

In an embodiment, the sensor is in data communication, either directly or indirectly, with the processor. In an embodiment, the sensor is configured to output the sensor signal to the processor directly, or via an analogue-to-digital converter.

In an embodiment, the sensor is a load sensor configured to sense the weight of inventory items in an inventory location.

A seventh aspect disclosed is a method of detecting events comprising: receiving a data stream comprising data samples; generating a moving gradient value representing an average gradient from a moving gradient window applied to at least some of the data samples in the data stream; and comparing the generated moving gradient value to one or more thresholds to detect the start and end of events.

An eighth aspect disclosed is a computer-readable medium having stored thereon computer executable instructions that, when executed on a processing device, cause the processing device to perform the method of the seventh aspect.

A ninth aspect disclosed is an event detection system comprising: a processor configured to: receive a data stream comprising data samples; generate a moving gradient value representing an average gradient from a moving gradient window applied to at least some of the data samples in the data stream; and compare the generated moving gradient value to one or more thresholds to detect the start and end of events.

The fourth-ninth aspects above may have any one or more of the features mentioned in respect of any of the other aspects, and may have any one or more of the features mentioned in respect of the first-third aspects of the invention, and vice versa.

### Definitions

The phrase “inventory location” as used in this specification and claims is intended to mean any location or space or receptacle or storage component or storage device in which inventory or consumable items may be stored and accessed, in whatever application, including but not limited to shelves, cabinets, storage bays, storage boxes, packaging, manual or electronic dispensers, vending machines, storage devices, including whether the inventory locations are permanent fixtures, semi-permanent, temporary, or portable or mobile within an environment or environments.

The term “computer-readable medium” should be taken to include a single medium or multiple media. Examples of multiple media include a centralised or distributed database and/or associated caches. These multiple media store the one or more sets of computer executable instructions. The term ‘computer readable medium’ should also be taken to include any medium that is capable of storing, encoding or carrying a set of instructions for execution by a processor of the mobile computing device and that cause the processor to perform any one or more of the methods described herein. The computer-readable medium is also capable of storing, encoding or carrying data structures used by or associated with these sets of instructions. The term ‘computer-readable medium’ includes solid-state memories, optical media and magnetic media.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

Number Ranges

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 is a block diagram of an implementation of the event detection system in an inventory management system in accordance with an embodiment of the invention;

FIG. 2 is a graph showing the raw sensor signal from a load sensor that is received and processed in the event detection system example;

FIG. 3 is a graph showing the digitized or digitally sampled raw sensor signal of FIG. 2;

FIG. 4 shows an example of a data buffer which temporarily stores the incoming digital sensor signal for processing;

FIG. 5 shows an example of a moving gradient window that is applied to data within the data buffer of FIG. 4 to generate a moving gradient value;

FIG. 6 shows a moving baseline window that is applied to samples within the data buffer to generate a moving baseline value;

FIG. 7 shows a flow diagram of the main processing steps in the event detection system in accordance with an embodiment of the invention;

FIG. 8 is a schematic diagram of an example real-time inventory management system in accordance with an embodiment of the invention; and

FIG. 9 is a flow diagram depicting steps in a calibration process associated with the real-time inventory management system in accordance with an embodiment of the invention.

### DETAILED DESCRIPTION OF PREFERRED EMBODIMENTS

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Overview

The invention relates to an event detection system and method which can be applied to any suitable application in which a raw signal or signals are received from which events must be detected or discriminated. Typically, the raw signals are from one or more sensors, depending on the application. By way of example only, the event detection system and method will be described in the context of a real-time inventory management system that employs load sensors. However, it will be appreciated that the principles and functionality of the event detection system and method may be adapted to any other suitable event detection application and any other sensors including, but not limited to, sensors detecting or sensing weight, pressure, force, sound, light, vibration, biological signals, or any other parameter, variable, signal or the like.

Real-Time Inventory Management System Application

Inventory management systems can be employed in various industries and applications wherever there is a desire to have a real-time snapshot of current inventory levels and/or record inventory interactions or transactions. Inventory management systems may for example be implemented in warehouses, stock rooms, hospitals, retail outlets, restrooms and store fronts where inventory locations such as, but not limited to, shelving, cabinets, bays, dispensers, storage devices or the like are provided for the various inventory items of different types. Inventory management systems may also be used in any other application where counting of consumable items is required, whether in commercial or residential environments. For example, in homes an inventory management system could be configured to monitor the stock of food and beverage items in the pantry or refrigerator. Each inventory location in a monitored inventory management system may comprise one or more sensors for detecting the presence or absence of inventory items, or change in weight of items.

An inventory management system monitors the sensor signals associated with the various inventory locations and generates data relating to the stock levels or number of items in each inventory location, for example by dividing the weight sensed by the sensors by the individual weight of the homogeneous items on or within the inventory location. Various actions or triggers can then be performed based on the inventory data, including automated reordering of items, recording data on the timing of interactions or transactions with the inventory location, such as restocking or removal of items, or the like. By way of example only, such inventory management systems may be employed for any suitable inventory items that are stocked in inventory locations such as shelves or bays including, for example, hardware components such as nuts and bolts or the like, through to medical supplies, such as plasters, bandages, drug capsules or other such granular items, including food and beverage items, and non-decanted food items in a box.

For any such inventory management systems, as there are often a large number of individual locations (e.g. bays or shelves for example) stocking a large array of items, it is often cost prohibitive to employ expensive and complex sensors in the bottom surface of each shelf or bay. It is therefore desirable to use low cost sensors, such as a strain gauge load cell or similar. However, such low cost sensors suffer from susceptibility to noise and/or drift of the sensor signals and therefore careful signal processing is required in order to detect true events or interactions within the inventory locations and to maintain accurate inventory data.

Hardware Configuration

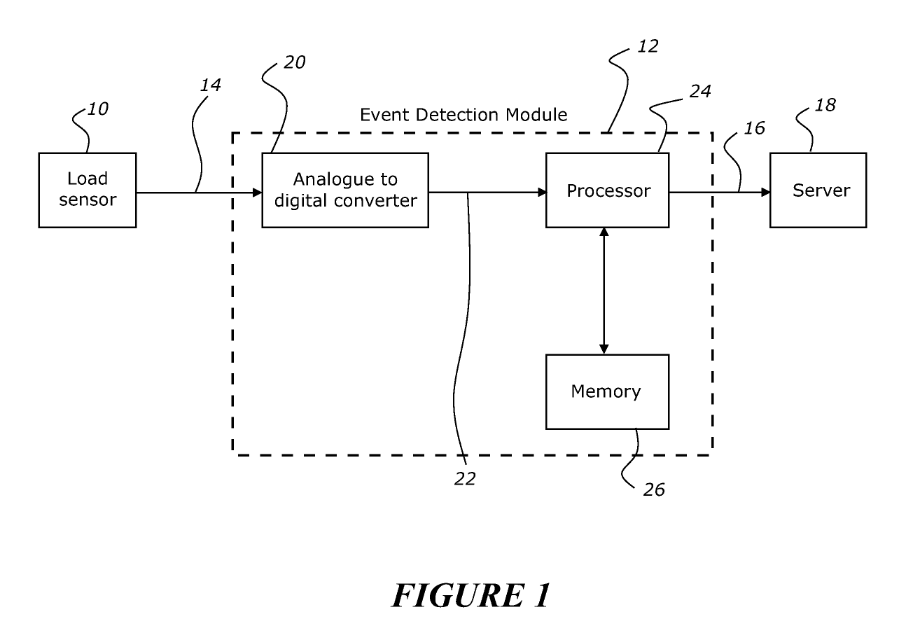

FIG. 1 shows an example of the main components associated with a single inventory location, e.g. shelf or bay for example, of an inventory management system. The inventory location typically comprises a load sensor 10, such as a strain gauge based load cell, that is mounted or coupled to or into the base surface of the bay such that it detects the load or weight of the inventory items within the bay. It generates a raw sensor signal, such as a voltage signal, normally in the range of millivolts, that is proportional to the sensed load or weight impinging on the load cell.

In this example, each inventory location comprises its own respective event detection module 12 that is configured to receive and process a raw sensor signal 14 from the load sensor and generate representative output event data 16 that is then transmitted to a central server or data processor 18 for further analysis or processing by the overall inventory management system. In this example, the load sensor 10 may be hardwired to the event detection module 12, which may be in the form of electronic circuitry provided on a printed circuit (PCB) board mounted to or associated with the inventory location. Likewise, the event detection module 12 may be hardwired to the central server 18 or alternatively may transmit or communicate with the server 18 over a network or wireless data link such as in applications where the server or data processor 18 is remote to the inventory locations being monitored. It will be appreciated that in alternative embodiments the raw sensor signals 14 from the load sensors of each inventory location may alternatively be sent directly, over a hardwired connection or network or wireless data link, to the central server 18 which is configured to execute or implement the event detection algorithm in a centralised fashion on all incoming load signals in parallel, rather than having dedicated event detection modules 12 on-board at each inventory location.

In this example, the load sensor is a resistor-based strain gauge load cell. In one example, the load cell is a 700 gram load cell with a 1 mV/V output rating, provided at an excitation of 3.67 volts results in a full scale output range of ±3.67 mV.

In this embodiment, the event detection module 12 comprises an analogue to digital converter (ADC) 20 that is configured to receive the raw voltage signal 14 from the load cell 10 and convert it into a digital sensor signal 22. In this example, the ADC 20 is a 24-bit analogue to digital converter. The sampling rate of the ADC may be controlled, and in this example is set in the range of 50-100 Hz, i.e. 50-100 samples per second of the raw sensor signal. In one example, the sample rate of the ADC 20 is 80 Hz, i.e. 80 samples per second. The processor may sample the ADC at 80 Hz or a lower frequency such as, but not limited to, 40 Hz for example, or alternatively at a higher frequency than the ADC sampling rate. This sampling rate of the processor may be configured based on its processing power, i.e. a powerful processor may sample at the full ADC sampling rate, but a less powerful processor may be configured to sample at a lower frequency. It will be appreciated that the ADC sampling rate and the processor sampling rate may be configured or selected as desired, based on the capability of the hardware devices used, and the frequencies may be higher than the example ranges given above.

While an ADC is employed in this embodiment of the event detection system, it will be appreciated that an ADC is not essential to all embodiments, and is optionally used depending on the type of sensor or sensors being employed in the event detection system. For example, in this embodiment, if a digital capacitive load cell was used, an ADC would not be required.

The event detection module 12 also comprises a processor 24 that is configured to receive and process the digital sensor signal 22. The processor may be a microcontroller or a microprocessor for example, or any other programmable electronic device. The processor 24 is configured to execute the event detection algorithm on the digital sensor signal data stream 22 and generate representative output event data 16 representing detected events. In this embodiment, the processor has associated memory 26 in which it temporarily maintains or stores a data buffer of the incoming digital sensor signal for processing, as will be described in further detail later.

Raw Sensor Signal

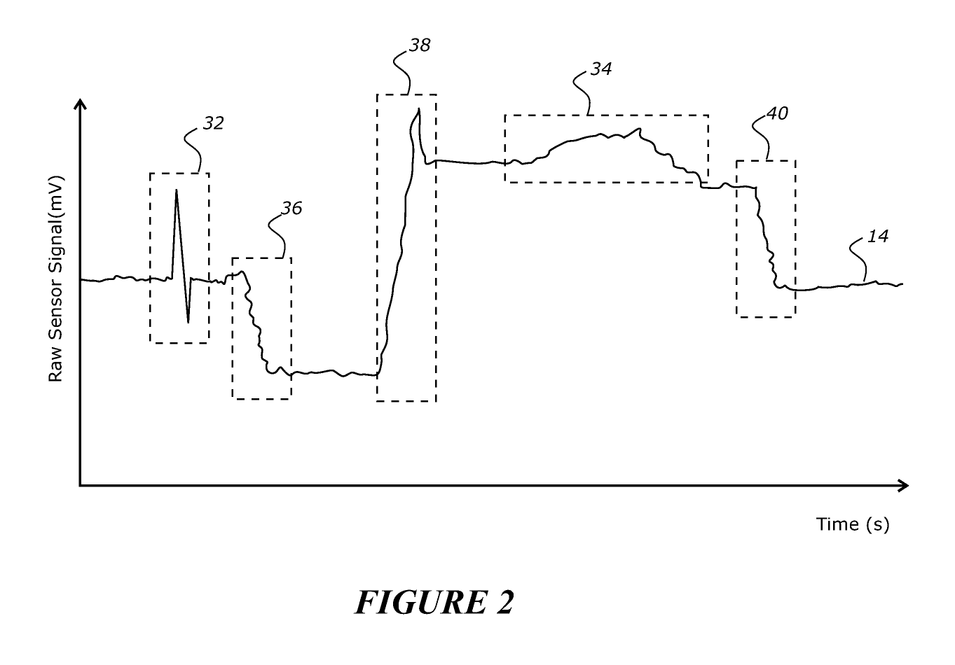

By way of example, FIG. 2 depicts an example of the raw sensor signal 14 generated by the strain gauge load cell 10. Time is represented on the horizontal axis, with the voltage signal in millivolts (mV) on the vertical axis. As mentioned, the objective of the event detection system is to discriminate between true events or interactions with the inventory in the bay or shelf (for example removal of inventory items, restocking of inventory items and the like) relative to other events or signal variation causes such as noise, drift, vibrations, atmospheric and physical interference, or similar. By way of example, the interaction depicted at 32 represents a noise spike, which could be generated by the inventory shelf or bay being bumped or knocked by a person, or an earthquake or some other force disruption that is not a true inventory interaction or transaction event that we are interested in. The signal movement at 34 represents signal drift which can be caused by various factors, including temperature or other environmental changes, or the general quality of the strain gauge load cell. The event detection system is configured to manage the problems of noise 32 and drift 34 such that those signal variations are not mistakenly considered true event interactions, such as those indicated at 36, 38 and 40. The interactions at 36, 38 and 40 are true events, e.g. inventory interactions or transactions, in which the strain gauge load cell detects removal of one or more inventory items or restocking of the inventory items.

Digital Sensor Signal

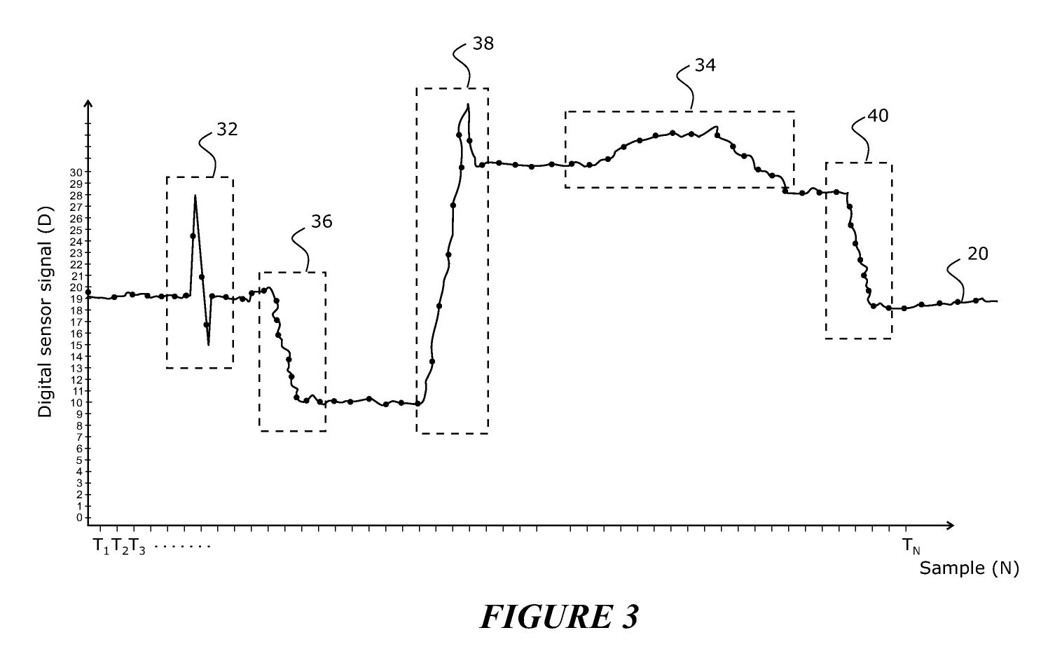

By way of example, FIG. 3 represents the digital sensor signal 22 generated by the ADC 20 of the event detection module 12. In particular, the horizontal axis represents the data sample number (N), which is equivalent to a discrete time, and the vertical axis represents 24-bit digital value (D) corresponding to the sampled voltage signal 14. As shown, the dots represent the digital value (D) sampled raw voltage signal for data samples T1, T2, T3 . . . to T_{N} at the sampling frequency. It will be appreciated that the resolution of the ADC and sampling frequency may be selected as desired, depending on the particular requirements of the event detection algorithm.

Data Buffer

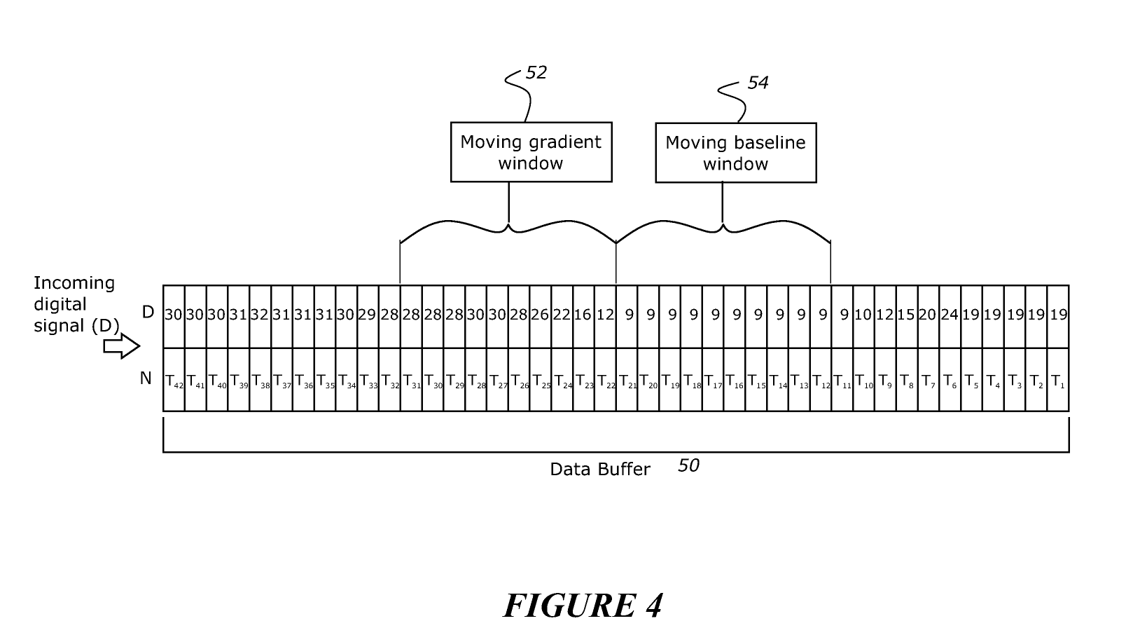

In this embodiment, the processor 24 of the event detection module 12 receives the data stream of digital sensor signal 22 and temporarily stores the incoming data samples in a data buffer 50 depicted in FIG. 4. The size of the data buffer may be selected to be any suitable length, as will be appreciated. In this embodiment, the data buffer is typically a first-in first-out (FIFO) data buffer, such as a circular buffer or similar. As discussed above, the processor 22 may be configured to sample the ADC at the sampling frequency of the ADC or alternatively a lower sampling frequency to generate the incoming stream of data samples for the data buffer.

In this embodiment, the event detection algorithm implemented by the processor 24 is configured to apply one or more filters to the data samples in the data buffer to extract variables for analysis to detect events and their associated parameters. In this embodiment, the processor applies two filters, firstly a moving gradient window 52, followed by a moving baseline window 54. In the configuration shown, the incoming data samples move through the moving gradient window 52 first, and then into the moving baseline window 54. In this embodiment, the windows 52 and 54 are immediately adjacent, although it will be appreciated that they may be displaced from one another or partially or fully overlap in other configurations depending on requirements. The variables calculated or generated by the filter windows 52 and 54 will be described in more detail in the following.

Moving Gradient Window

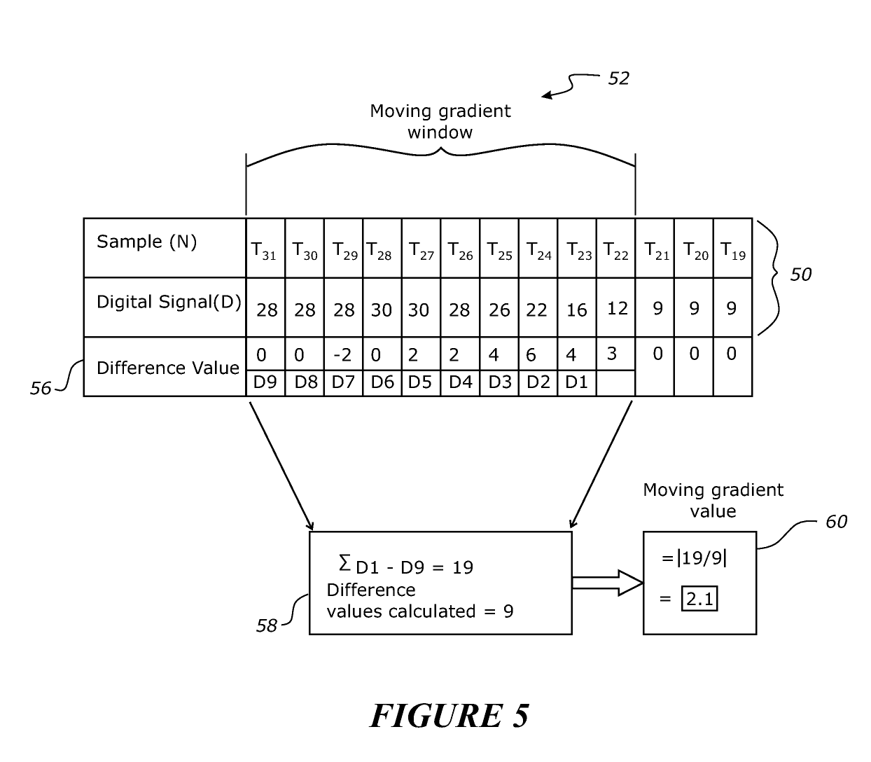

Referring to FIG. 5, an example of the moving gradient window 52 applied to the data buffer 50 will be explained in further detail. In this embodiment, the moving gradient window 52 is of a length that captures a predetermined number of data samples in the data buffer. In one configuration, the length of the window 52 may be smaller than the length of the data buffer 50, although it will be appreciated that the window could encompass all data samples in the data buffer in alternative embodiments. In the example of FIG. 5, the window comprises a length of 10 data samples by way of illustration only. The length of the moving gradient window 52 is specifically selected based on one or more factors including, but not limited to, the sampling frequency of the ADC or the sampling rate of the processor, the desired sensitivity of the event detection, and the nature of the inventory management system, such as the typical weight range of the inventory items being monitored. For example, if the sampling rate of the processor is 80 Hz, the window 52 may have a length of 80 samples in one configuration. In some embodiments, the length of the moving gradient window may also be based at least partly on the unit weight of the inventory items being monitored. For example, lighter weight inventory items may have a short length window, than heavier inventory items.

In this embodiment, the moving gradient window 52 is updated at the sampling frequency of the processor, which may match the ADC sampling rate or be a lower sampling rate depending on the configuration. In particular, for each new data sample that moves into the window, a new moving gradient value is calculated or generated. However, it will be appreciated that lower update frequencies for the window 52 may be employed. In this embodiment, the moving gradient value generated by the moving gradient window 52 represents a moving gradient of the digital sensor signal. In this embodiment, the moving gradient is calculated by determining the difference value between adjacent data samples within the window as shown at 56. The gradient window 52 then sums the individual difference values and divides the total by the number of calculated difference values samples in the window at shown at 58. The absolute value of the quotient of the division is output as the moving gradient value, in this embodiment as shown at 60. Therefore, the moving gradient value represents an average of the gradient of the signal within the window. If the magnitude of total rises is equal to the magnitude of total falls, then the moving gradient value will be zero. Alternatively, if the magnitude of rises is greater than the magnitude of falls, or vice versa, then the moving gradient value will be greater than zero. In this embodiment, the difference values are generated for each pair of adjacent samples in the moving gradient window, however in alternative embodiments it will be appreciated that the difference values may be calculated at a lower frequency such as between every second or third data sample, or some other frequency or sub-sample of the data samples within the moving gradient window.

Moving Baseline Window

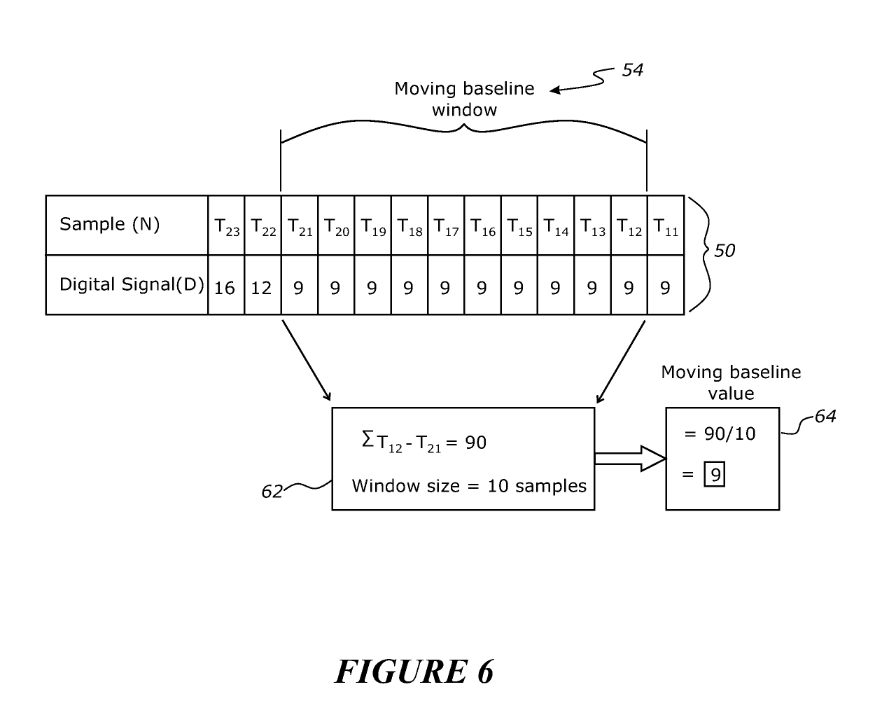

Referring to FIG. 6, an example of the moving baseline window 54 employed in the event detection algorithm will be described in further detail. In this embodiment, the moving baseline window 54 is configured to follow the moving gradient window 52 in the data buffer 50. In particular, the data samples exiting the moving gradient window 52 immediately enter the moving baseline window 54. However, it will be appreciated that in an alternative embodiment the moving baseline window 54 may be delayed or displaced further behind the moving gradient window 52 or alternatively may partially overlap or entirely overlap with the moving gradient window 52.

In this embodiment, the moving baseline window 54 is configured to generate a moving average or rolling average with respect to the data samples within the window. The length of the window, by way of illustration only, is 10 data samples, although it will be appreciated that the length of the window may be specifically selected based on one or more factors including, but not limited to, the ADC sampling frequency or processor sampling frequency, the length of the gradient moving window, the desired sensitivity of the event detection algorithm, and the nature of the inventory management system. In one embodiment, the moving baseline window is configured to have a length that is a function of the length of the moving gradient window. For example, in one configuration, the moving baseline window may be twice the length of the moving gradient window. As shown at 62, the moving baseline window takes the sum of the data samples within the length of the window and then divides that by the window size, i.e. the number of data samples in the window (window length) to generate the moving baseline value as shown at 64. As mentioned, the moving baseline value represents a rolling average or moving average of the digital sensor signal within the moving baseline window.

Like with the moving gradient window, the moving baseline value 64 is updated or calculated at the sampling frequency of the processor, which ay match the ADC sampling frequency or may be a lower sampling rate depending on the configuration, such that a new moving baseline value or rolling average is calculated each time a new sample enters the moving baseline window 54. However, it will be appreciated that the update frequency for calculating the moving baseline window may be reduced if desired.

Event Detection Algorithm

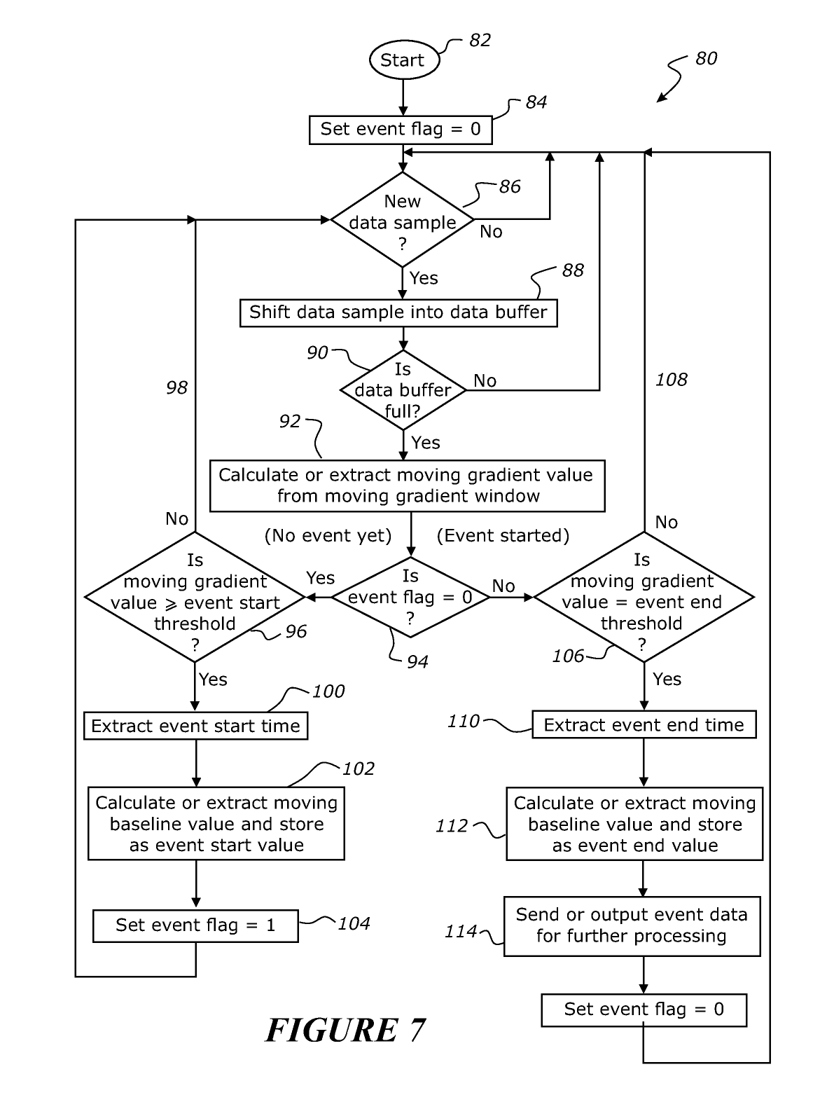

Referring to FIG. 7, an example event detection algorithm executed by the processor 24 in the event detection module 12 will be described in further detail. It will be appreciated that this algorithm is one particular example of the detection algorithm.

In brief, the event detection algorithm constantly or continuously compares the moving gradient value 60 generated by the moving gradient window 52 against event start and end thresholds (which may be predetermined or otherwise dynamically updated and varied depending on the configuration) that represent the start and end of an event, such as an interaction of removing or restocking inventory items into the bay or shelf associated with the load cell sensor signal being analysed. The event detection algorithm generates event output data representing the detected events. The output event data may comprise various representative information of the detected event. In one configuration, the output event data comprises data indicating that an event has been detected, and data indicative of the digital signal level before the event and after the event. For example, the output event data may comprise the moving baseline value 64 from the moving baseline window 54 before and after the event, i.e. the event start and end values. Additionally, the output event data may comprise time stamp data or time data indicative of the sample number or time value associated with the detected event, such as but not limited to the event start time and the event end time.

In some configurations, each event detection module 12 may be programmed or configured or stores a data value representing an inventory unit weight value (e.g. ‘SKU weight’) indicative of the weight of a single unit of the type of inventory stored in its associated inventory location. In such configurations, the stock or inventory levels before and after detected events can be determined by the event detection modules. For example, the event start and end values represent the total sensed weight of the inventory items in the inventory location, and the quantity or stock levels (i.e. integer number of items) before and after the event can be deduced by dividing those weights by the stored inventory unit weight value. In such configurations, the output event data may comprise data indicative of the calculated stock levels before and after the detected event, and this may be transmitted to the central server for updating the data in the real-time inventory management system. In some forms, the output event data may only comprise the event end value and/or calculated end stock level (count value) after the detected event for transmission to the server, which represents the real-time count value. In alternative configurations, as explained below, a central server or data processor may be configured to store the inventory unit weight values associated with each different inventory location being monitored, and performs the stock level calculations based on the event start and end values from the output event data.

Referring to FIG. 7, a particular implementation of the event detection algorithm 80 will be described. Upon starting, the algorithm sets the event flag to zero as shown at 84 which indicates that no current event has been detected. The algorithm then polls the digital sensor signal 22 output from the ADC 20 for new data samples as shown at 86. If there is a new data sample, that data sample is shifted into the data buffer 50 as shown at 88. The algorithm then considers whether the data buffer is full as shown at 90. If it is not full, it waits for further new data samples. If it is full, the algorithm extracts the moving gradient value 60 from the moving gradient window 52 as shown at 92. The event flag is then checked at 94. If the event flag is zero, i.e. no current event detected, then the moving gradient value is compared with an event start threshold as shown at 96. If the current moving gradient value 60 is less than the event start threshold, then the algorithm returns to the start awaiting a new data sample as shown at 98. Alternatively, if the current moving gradient value 60 is greater than or equal to the event start threshold, then this represents the start of an event. In this embodiment, the event start and end thresholds are determined using empirical methods. The thresholds are based on the particular set-up and location of the load sensor cell and environment within which it is operating. For example, for any particular set-up or configuration, data is captured from a range of events (interaction and environmental) and analysed to determine the appropriate threshold values.

Once an event is detected, the event start time is extracted at 100 and stored in memory. The event start time may for example be the time associated with the latest data sample to enter the data buffer 50, or alternatively some other time associated with the data samples in the data buffer 50. The current moving baseline value 64 is then extracted from the moving baseline window 54 and stored as the event start value is shown at 102. The event flag is then set to 1 as shown at 104 to indicate that an event is in progress. The algorithm then returns to the start to receive the next data sample.

Once an event is in progress, the algorithm continues as previously described until reaching the event flag decision at 94. As the event flag is now set as 1, i.e. an event has started, the extracted moving gradient value 60 for each new data sample is then compared with an event end threshold as shown at 106. In this embodiment, the event end threshold is set to approximately zero. If the current moving gradient value for the current data buffer 50 has not fallen back to approximately zero then the algorithm returns to the start awaiting the next data sample as shown at 108. If the current moving gradient value 60 is zero for a predetermined time period, this signifies the end of the event and the event end time is extracted and stored in memory as shown at 110. In alternative embodiments, the end of the event may be detected as corresponding to the initial time when the moving gradient value 60 is zero, without the value 60 having to remain stable at that level for a predetermined time period. Like with the event start time, the event end time may be time associated with the latest data sample to enter the data buffer 50 or some other time value associated with the data samples in the data array buffer. An event end value is then extracted and stored from the moving baseline window 54 to associate with the end of the event as shown at 112. In this embodiment, the current moving baseline value 64 is not extracted at the event end value. Rather, the algorithm is configured to allow the data samples within the moving gradient window 52 to filter into the moving baseline window 54, for example by allowing 10 new data samples (the length of the moving gradient window) to shift into the data buffer 50. Once the moving baseline window comprises the data samples from the moving gradient window, the moving baseline value 64 is extracted and stored as the event end value. In other embodiments, the event end value may be configured to be the moving gradient value from the moving gradient window 54 after some predetermined time period from detection of the end of the event, such as from when the moving gradient window has refilled with new data values following the end of the event.

The event detection algorithm then sends the output event data 114, for example comprising data indicative of the event start and end times, and the event start and end values, is sent and/or stored for further processing. The event flag is then set to zero, indicating that the event is completed and the algorithm returns to the start awaiting new data samples. In some embodiments, the event detection algorithm may be configured to send output event data that only or at least comprises weight data representing the inventory level following the detect event. In this example, the weight data may be in the form of the end event value, which represents or is indicative of the total weight being sensed at the inventory location after the detected event.

Typically, the circuitry associated with the inventory locations is powered by a DC power supply converted from an AC mains supply. In some embodiments, the circuitry of the event detection modules 12 may comprise a back-up power source or sources, such as a battery or capacitor, that provide sufficient power to enable the currently sensed data in the data buffers to be written to a non-volatile memory in the event of an AC mains supply outage. The data can then be retrieved from memory and processing continued once the power supply is restored.

Further Data Processing

It will be appreciated that the output event data generated by the event detection algorithm may be received by a central processor or server that is implementing a real-time inventory management system. In particular, the data may be used to update the real-time inventory levels of each inventory location (e.g. bay or shelf of dispenser or the like) being monitored. For example, the detection of an event signals an interaction with the inventory location, and this may be logged. Additionally, the event start and event end values may be analysed to determine the change in stock or inventory resulting from the interaction, as explained below.

In an embodiment, the central server or data processor implementing the real-time inventory management system stores in memory data indicative of the various inventory unit weight values (e.g. ‘SKU weight’) associated with the types of inventory being stored in the monitored inventory locations. The central server is able to calculate and update stock levels for each location based on the stored inventory unit weight values upon receiving output event data relating to one or more of the inventory locations. For example, the event start and end values represent the total sensed weight of the inventory items at an inventory location, and the quantity or stock levels (i.e. integer number of items) before and after the event can be deduced by dividing those total weights by the stored inventory unit weight value. For example, if the inventory location comprises inventory items weighing 1 gram (inventory unit weight value), and the event start value represents 100 grams (based on a conversion from the load sensor voltage to weight) and the event end value represents 120 grams, then the system can calculate that 20 new inventory items have been re-stocked into the inventory location during the event and the current stock value is 120 items. Alternatively, if the event end value represents 80 grams, then the system can calculate that 20 items were removed during the interaction and the current stock level is 80 items. It will be appreciated that in embodiments where the received output event data only comprises an event end value representing the sensed total weight at the inventory location after the detected event, this is sufficient to deduce or calculate the current stock level, and to also calculate the level of change since the calculated stock level of the previous detected event. This event information received at the central server can be tracked in real-time to keep the stock levels in the inventory data up to date, and to also log the individual interactions with each inventory location for later review and analysis.

### Example Embodiment—Real-Time Inventory Management System

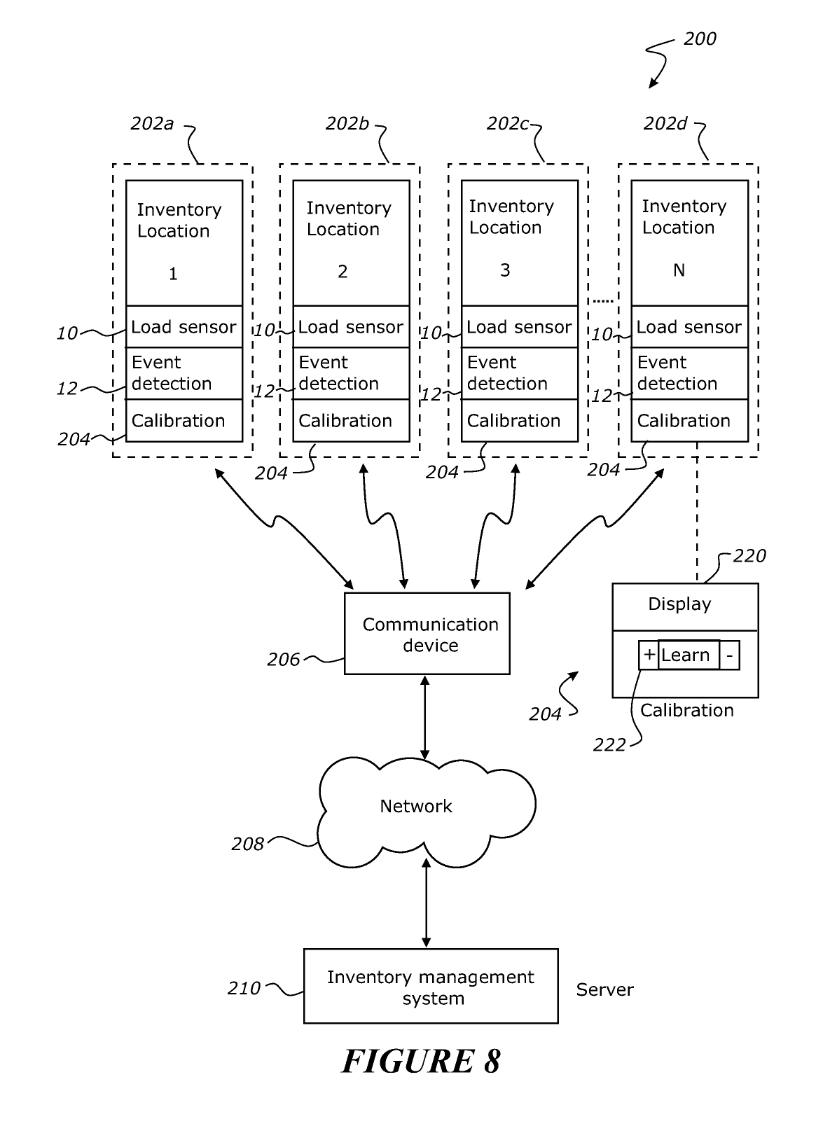

With reference to FIG. 8, an implementation of a real-time inventory management system using the event detection algorithm will be explained in further detail by way of example only. Like reference numerals represent like components.

In this embodiment, the real-time inventory management system 200 is configured for remote sensing and monitoring of the inventory stock levels in real-time of a number of inventory locations, generally indicated at 202a-202d. It will be appreciated that there may be any number of inventory locations. The inventory locations may shelves or bays or dispensing devices that are physically linked or otherwise generally in the same geographical location, e.g. room or building, or alternatively the inventory locations may be spread amongst different geographical locations, or a combination of these.

For the purposes of explanation only, in this example the inventory locations 202a-202d are monitored bays or shelves on a medical dispensary or medical supplies cupboard or container that stocks a number of different medical supply items, such as plasters, bandages, saline capsules, medical gloves, swabs and the like. Such inventory items are typically light weight items, such as granular-weight type items, and each typically weighs in the order of a few or tens of grams or fractions of grams. However, it will be appreciated that the general principles of the configuration may be applied to any other suitable type of inventory locations and other types of inventory items such as, but not limited to, industrial items, consumer or household items, or general consumables, whether in the context of in the context of public, private, or business environments.

In this embodiment, each inventory location (bay or shelf for example) 202a-202d in the dispensary comprises its own load sensor 10 and event detection module 12 of the type and configuration described with reference to FIG. 1. In this embodiment, optionally each inventory location 202a-202d also comprises a calibration module 204 that generates calibration data, which be described in further detail later. In this embodiment, each inventory location is in data communication, either hardwired, wirelessly or a combination thereof, over respective data links with a communication device 206 associated with the medical dispensary. The communication device 206 may be any suitable form of programmable electronic device or system, such as a general purpose computer, dedicated data server or router, or the like, any typically comprises a processor, memory and communication interface. The communication device receives the output event data 16 generated by the event detection modules of the inventory locations, and also any associated calibration data, and relays or forwards this over a data communication link or data network 208, such as the internet, to a central server or data processor 210 that is configured to execute or is operating the inventory management system that maintains and updates the stock or inventory level data for the inventory locations based on the incoming data in the manner previously described.

It will be appreciated that the inventory management system operating at the server 210 may be in the form of a software application program. The server or data processor 210 typically comprises a processor, memory and data storage components, to enable execution and operation of the inventory management software. It will be appreciated that users of the inventory management system may have direct access to the data processor 210, for example it may be in the form of a general purpose computer running the software and they can access and monitor stock levels or configure the system for automatic re-ordering of stock via a graphical user interface (GUI) which displays stock levels associated with the different shelves or bays (inventory locations) in the dispensary. In alternative embodiments, the inventory management system may be operating as a Software as a Service (SaaS) platform or otherwise be operating in a remote data server or ‘cloud’ that a user may access over a network, such as the internet, on a suitable electronic user device such as, but not limited to, a general purpose computer, whether a desktop or laptop, tablet device, smart phone device or the like. In one form, the inventory management system may be hosted as a website that the user may access via a website browser on their device and login to access the information relating to their monitored inventory. In another form, the inventory management system may be cloud service that is accessible via a user application program downloaded and operating on the user's electronic device.

Calibration and Learning Functionality

In this embodiment, although also applicable to other applications of the inventory management system and event detection system generally, a calibration and learning functionality is provided. In this example system 200, each inventory location is provided with a calibration module 204 that is operable to generate calibration data based on user interaction.

As previously described, the integer stock or inventory levels indicating the number of items in each inventory location 202a-202d, and/or the number of items re-stocked or removed during a interaction with the inventory location, is based on the event start and end values that are indicative of the weight of the items before and after an event in an inventory location, and the inventory unit weight values. The inventory unit weight values (SKU weight) are indicative or average or otherwise nominal value representing the expected individual weight of a type of inventory item. However, the weight of inventory items of the same type tend to have fractional variances relative to the expected individual weight, as items of the same type can have minor variances relative to each other despite otherwise being substantially homogeneous. These inconsistencies in weights, particularly in the context of measuring lightweight items in the order of a few or tens of grams, or less than 1 gram such as fractions of grams, can generate long-run errors in the stock levels being calculated. In view of this, a calibration module and associated algorithm is provided in the system to assist in optimising or refining the data representing the stored SKU weights associated with types of inventory items being stored in each individual inventory location to reduce or minimise long-run errors caused by these weight discrepancies.

In this embodiment, the calibration functionality comprises a calibration module 204 mounted or associated with each inventory location. For example, a calibration module may be associated with each shelf or bin or bay of the medical dispensary, and is typically in data communication with the event detection module 12. In this embodiment, each calibration module 204 is provided with a display 220 that is configured to display the current or real-time calculated numerical stock level associated with its inventory location, and optionally other textual, graphical or numerical data including user instructions or calibration instructions or the like. In some embodiments, the display 220 may be operable to graphically depict various stock levels via icons, imagery or colours. In one example, the colour of the displayed inventory stock level may change depending on the level, such as a ‘red’ zero for out of stock (i.e. zero stock), ‘orange’ number for low stock that is below a predetermined threshold, and ‘green’ number for acceptable level of stock that is above a predetermined threshold. It will be appreciated that the stock level data may be determined for the display in various ways. In one configuration, the calibration modules 204 may be in data communication with the inventory management system and may receive data updates indicated the current stock levels as calculated by the remote inventory management system for display. In another configuration, each calibration module 204 stores data indicative of the SKU weight associated with the type of inventory items stored in its associated bay or shelf, and calculates locally the numerical stock levels based on the output event data 16 from the event detection module 12 and the SKU weight value for display. In another configuration, the event detection module 12 may store data indicative of the SKU weight value and may calculate the numerical stock levels based on the output event data and send those to the display and/or calibration module 204 for display.

In addition to the display 220, each calibration unit also comprises a user interface 222. The user interface may be in the form of operable buttons, dials or switches, or a touch-screen graphical user interface which could either be separate or integrated with the display 220. In this embodiment, the user interface comprise a stock level adjustment interface or inputs that are operable by a user to adjust the stock level calculated and displayed on the display 220 during the calibration modes to be described. In one form, the stock level adjustment interface is in the form of ‘+’ and ‘−’ buttons or items that are operable by a user to manually increment or decrement the calculated stock level data.

The user interface 222 may also comprises one or more other calibration buttons that enable a user to initiate or interact with the calibration process. In this example an operable ‘learn’ button is provided, and its operation will be discussed further in the following.

In this embodiment, each calibration module 204 has an initial calibration mode and an in-use calibration mode. Each mode will be explained further below.

Initial Calibration Mode

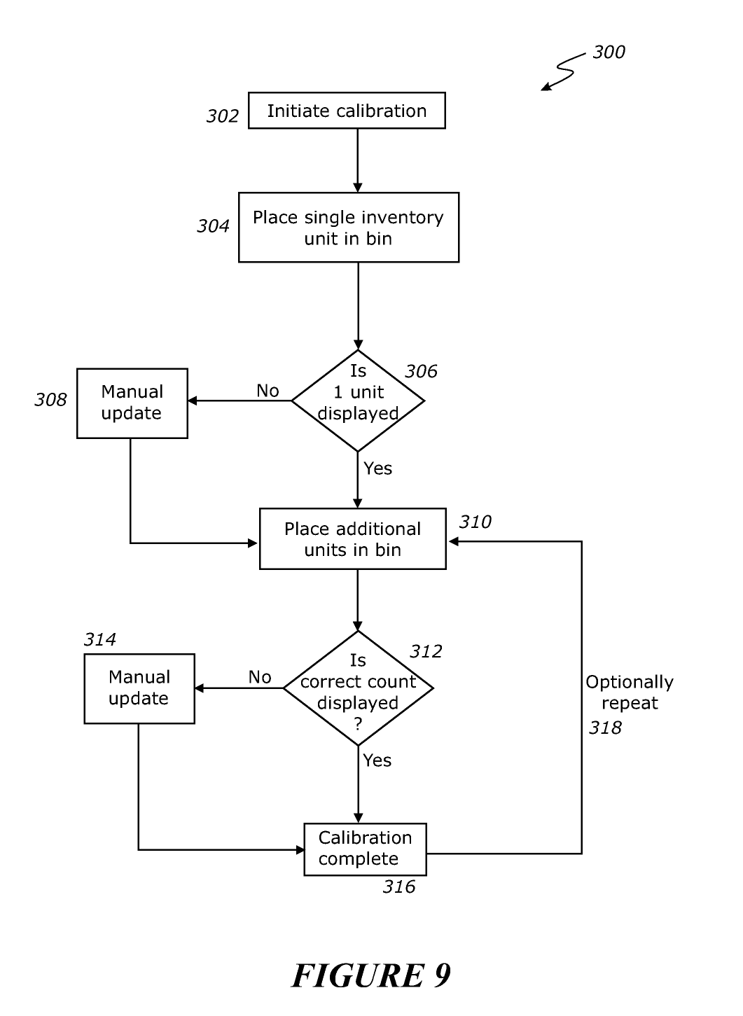

To calibrate the initial SKU weight data value associated with each inventory location 202a-202d (e.g. a bay or bin in the dispensary), the user may be prompted or otherwise initiate an initial calibration mode of the calibration module 204 for each bin. The initial calibration process 300 for a single bin will be described with reference to FIG. 9, but it will be appreciated this can be repeated for the remaining bins that are being monitored in the inventory management system 200. The user calibration instructions in this example are relayed to the user via displayed text instructions on the display 220 associated with the bin.

Referring to FIG. 9, upon powering up the bin for initial use, the bin should be empty or the user is prompted to empty the bin via a message on the display 220. The initial calibration process may then either automatically initiate 302 or the user may manually trigger the calibration process via the user interface 222, such as by pressing the ‘learn’ button. After initiation 302, the user is then instructed 304 via the display 220 to place a single inventory item (of the type intended to be stored in the bin) in the bin and then press the ‘learn’ button, and is instructed to check the count displayed is ‘1’. The event detection module 12 detects this event, and generates output data which includes the event end value that is indicative of the total weight of items in the bay. As previously discussed, the calibration module 204 then either locally calculates the inventory count or receives this data from the inventory management system for displaying on the display 220, the count being calculated based on the currently stored data representing SKU weight for units in that bin, if such data is already stored. If a correct stock or count value of ‘1’ is displayed at 306, then no change to the stored SKU weight data value is made and the calibration process moves to the next step 310. If an incorrect stock or count value is displayed at 306 or if no count value is displayed (for example due to no SKU weight data value being currently stored for that bin), then the user is prompted to manually adjust 308 the count value manually via the user interface 222, such as by pressing the ‘+’ button once to increment the displayed count value to 1, which updates the stock level for that bin. If manual adjustment of the single count at 308 is required, the output event data is used to update or refine the stored SKU weight value for that bin. For example, the event end value of the output event data is set as the SKU weight value for that bin, as it represents the load sensor baseline value for the bin when it contains a single unit.

The calibration process then continues by instructing the user at 310 to place one or more additional units into the bin, and is instructed to check that the displayed count value on the bin equals the number of additional units placed into the bin. The user then places one or multiple additional units into the bay. The user at step 312 checks the displayed count value corresponds to the total number of units that are in the bin. If the displayed count value is correct then no adjustment is made to the stored SKU weight value for that bin, and the user can complete the calibration process at 316 by pressing the ‘learn’ button for example. If the displayed count value is incorrect, the user may manually adjust the count value via the user interface 222, such as by toggling the ‘+’ and ‘−’ buttons as required to increment or decrement the count value to the correct total. Once the correct count value is displayed, the user can close the calibration process at 316 by pressing the ‘learn’ button, which then triggers an adjustment or refinement to be made to the SKU weight value for that bin. For example, a modified SKU weight value is determined or calculated based on the correct number of units in the bin as adjusted manually by the user and the output event data comprising the event end value that represents the load sensor baseline value for the bin after the additional units are inserted. For example, the adjusted SKU weight value is calculated based on the weight represented by the output event data divided by the adjusted count value.

Optionally, the user may repeat the previous steps 318 one or more times by continuing to add additional units into the bin, or alternatively by removing one or more units from the bin, checking the displayed count value, adjusting it if required by the user interface, and closing the calibration to thereby update or adjust the SKU weight value associated with that bin.

In-Use Calibration Mode

The in-use calibration mode operates in a similar manner to the initial calibration mode, but is intended to allow the user to adjust any inaccuracies in the displayed count value during everyday use after the initial calibration was carried out. For example, if a user notices that the displayed stock level is not correct in that it does not correspond with the number of items in the bay, the user can initiate the in-use calibration mode by pressing the ‘learn’ button and may manually correct the displayed stock level and data in the system via the user interface, such as by operating the ‘+’ and ‘−’ buttons as required to increment and decrement the counter value to the correct value. As with the initial calibration mode, once the correct counter value is displayed, the user can close the calibration sequence by pressing the ‘learn’ button again, which then triggers an adjusted SKU weight value to be calculated and stored against that bin in the system data in the same manner as described in the initial calibration mode.

While the above calibration functionality has been described in the context of physical calibration modules with user interfaces and displays on each bin or bay or shelf of the dispensary, it will be appreciated that the calibration functionality may alternatively be carried out or implemented in software. For example, the calibration interface may be presented as a graphical user interface (GUI) via the accessible inventory management system. In one form, the user may access the inventory management system on their user electronic device while standing in front of the dispensary or inventory locations, and the calibration GUI may present the same functional options as the physical calibration modules. For example, the calibration GUI may display the current stock level associated with the monitored bays of the dispensary, and provide a graphical user interface having actionable buttons or icons that the user may operate, e.g. via a touch screen or mouse click or other user input interface associated with the electronic device, to interact with the calibration functionality, such as ‘+’ and ‘−’ buttons or other user interface for adjusting the count value, and a ‘learn’ button to close or progress the calibration function. A text or instruction field may also be provided in the GUI to instruct the user through the calibration process.

In summary, the calibration functionality and modes are intended to enable a refined SKU weight value for each bay to be calculated during initial set-up and in-use, based on manual user adjustment and feedback on the calculated stock levels relative to the actual stock levels. Effectively, the user adjustment feedback represents error data indicative of any error between the calculated stock level and the actual observed stock level. The calibration data, such as the adjusted SKU weight values and updated stock levels, as calculated by the calibration functionality is transmitted or sent to the required modules in the inventory management system, such as typically the main server 210, so that the updated SKU weight values can be stored in the server for future stock level calculations. In alternative configurations where the stock levels are calculated locally by the electronic circuitry associated with each bin, then the updated SKU weight values are stored locally to refine the future stock level calculations, before that stock level data is transmitted to the central server 210. The updated or optimised SKU weight values generated by the calibration processes is intended to enhance the stock level count accuracy, particularly in applications where the inventory items for a bin vary by fractional weights.

While the event detection and calibration modules have been described as separate modules for clarity, it will be appreciated that they may be integrated as a single module or circuitry board, and/or may be executed on the same programmable device, such as a microprocessor, microcontroller, digital signal processor, Application Specific Integrated Circuit (ASIC) or the like. The general functionality of these modules may be integrated or further distributed throughout the inventory management system in alternative embodiments.

General

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the foregoing, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the invention. Additional elements or components may also be added without departing from the invention. Additionally, the features described herein may be implemented in software, hardware, as a business method, and/or combination thereof.

In its various aspects, the invention can be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

The foregoing description of the invention includes preferred forms thereof. Modifications may be made thereto without departing from the scope of the invention as defined by the accompanying claims.

1. A method of detecting events and updating inventory data in an inventory management system that is configured to sense and monitor inventory levels at one or more inventory locations, each inventory location comprising a load sensor that is configured to sense the weight of inventory items at the inventory location and generate a representative sensor signal, the method being executed by a data processor or processors and for an inventory location the method comprising:
receiving a digital signal comprising data samples that represent the sensor signal generated by the load sensor;
moving the data samples of the digital signal through a data buffer;
generating a moving gradient value representing an average gradient from a moving gradient window applied to at least some of the data samples in the data buffer;
comparing the generated moving gradient value to one or more thresholds to detect the start and end of events, the events representing an interaction with the inventory location in which the inventory level changes; and
generating output event data representing the detected event, the output event data at least comprising weight data representing the inventory level following the detected event for updating the inventory data associated with that inventory location.

2. A method according to claim 1 wherein the data buffer for an inventory location is a circular data buffer.

3. A method according to claim 1 or claim 2 wherein the data buffer for an inventory location is a first-in first-out (FIFO) data buffer.

4. A method according to any one of the preceding claims wherein the method for an inventory location comprises generating a new moving gradient value for each new data sample moved into the data buffer.

5. A method according to any one of the preceding claims wherein the moving gradient window for an inventory location generates the moving gradient value by calculating the average of the difference between adjacent data samples within the moving gradient window of the data buffer.

6. A method according to claim 5 wherein the moving gradient value is the average gradient represented by the sum of the different values between adjacent data samples within the moving gradient window of the data buffer divided by the number of difference values calculated within the moving gradient window.

7. A method according to claim 5 wherein the moving gradient value is calculated from a uniformly spaced sub-sample of the data samples in the moving gradient window, the sub-sample being at least every 2^{nd} data sample or a lower frequency, and wherein the moving gradient value is the average gradient represented by the sum of the difference values between adjacent data samples within the sub-sample divided by the number of difference values calculated for the sub-sample.

8. A method according to claim 6 or claim 7 wherein the moving gradient value is the absolute value of the average gradient.

9. A method according to any one of the preceding claims wherein the method comprises comparing the moving gradient value to an event start threshold to detect the start of an event, and then comparing the subsequently generated moving gradient values to an event end threshold to detect the end of the event.

10. A method according to claim 9 wherein the digital signal is sampled from the sensor signal of the load sensor at a sampling frequency, and the moving gradient value is compared to the event start and end thresholds at the same sampling frequency such that the moving gradient value is compared to the thresholds for each new data sample in the data buffer.

11. A method according to claim 9 wherein the digital signal is sampled from the sensor signal of the load sensor at a sampling frequency, and the moving gradient value is compared to the event start and end thresholds at a lower frequency than the sampling frequency, such as every n^{th} data sample, where n≥2.

12. A method according to any one of claims 9-11 wherein the method comprises detecting the end of the event once the moving gradient value equals or drops below the event end threshold.

13. A method according to any one of claims 9-12 wherein the end of the event is detected once the moving gradient value equals or drops below the event end threshold for a predetermined time period.

14. A method according to any one of the preceding claims wherein the method comprises storing the time or data sample number associated with the data samples within the data buffer upon detection of the event.

15. A method according to claim 14 wherein the method comprises generating and storing an event start time and an event end time representing the start and end of a detected event.

16. A method according to any one of the preceding claims wherein the method comprises generating output event comprising an event start value that represents the weight of the inventory items at the inventory location at or associated with the start of the event, and an event end value that represents the weight of the inventory items at the inventory location at or associated with the end of the event.

17. A method according to claim 16 wherein the method further comprises generating a moving baseline value representing a rolling or moving average of the digital signal within a moving baseline window applied to the data buffer.

18. A method according to claim 17 wherein the method comprises generating the event start value based on the moving baseline value generated by the moving baseline window at the time the moving gradient value is equal to or exceeds an event start threshold.

19. A method according to claim 17 or claim 18 wherein the method comprises generating the event end value based on the moving baseline value generated by the moving baseline window at the end of the event.

20. A method according to claim 19 wherein the method comprises generating the event end value based on the moving baseline average generated by the moving baseline window once it contains the data samples from the moving gradient window at the time when the moving gradient value equaled an event end threshold.

21. A method according to any one of claims 16-20 wherein the output event data comprises the event start value and event end value.

22. A method according to claim 21 wherein the output event data further comprises the event start time and event end time representing the start and end of the detected event.

23. A method according to any one of claims 16-22 wherein the moving gradient window and moving baseline window are applied to a subset of the data samples within the data buffer.

24. A method according to any one of claims 16-23 wherein the method comprises applying the moving gradient window to incoming data samples of the data buffer first, followed by the moving baseline window.

25. A method according to any one of the preceding claims wherein the method comprises generating output event data that comprises data representing the change in inventory items in the inventory location from the detected event.

26. A method according to any one of the preceding claims further comprising calculating a numerical inventory level for the inventory location based on the weight data in the output event data and data indicative of the inventory unit weight value of a single unit of the type of inventory stored in the inventory location.

27. A method according to claim 25 wherein the method further comprises receiving calibration data from a calibration process and updating or adjusting the inventory unit weight value based on the calibration data to increase accuracy of the calculated numerical inventory level.

28. A method according to claim 27 wherein the calibration process comprises displaying the current calculated inventory level to a user of the system following a detected event, receiving adjustment data indicative of any error in the displayed inventory level based on user observation of the actual inventory level, and calculating or determining an adjusted inventory unit weight value based on the adjustment data and the weight data associated with the detected event.

29. A method according to claim 27 wherein the calibration process comprises displaying the current calculated inventory level on a display at the inventory location, and receiving any adjustment data via an operable user interface at the inventory location.

30. A method according to claim 27 wherein the calibration process is operable via a graphical user interface (GUI) of the inventory management system that is accessible by a user via a user electronic device having a display, the GUI displaying the current calculated inventory level associated with the inventory location and displaying an operable user interface to enable the user to provide adjustment data.

31. A method according to any one of the preceding claims wherein the method is applied in parallel to each respective inventory location being monitored in the inventory management system.

32. A computer-readable medium having stored thereon computer executable instructions that, when executed on a processing device, cause the processing device to perform a method of any one of claims 1-31.

33. An inventory management system for detecting events and updating inventory data, the system configured to sense and monitor inventory levels at one or more inventory locations, each inventory location comprising a load sensor that is configured to sense the weight of inventory items at the inventory location and generate a representative sensor signal, the system comprising: a processor or processors, and for each respective inventory location the processor or processors being configured to:
receive a digital signal comprising data samples that represent the sensor signal generated by the load sensor;
move the data samples of the digital signal through a data buffer;
generate a moving gradient value representing an average gradient from a moving gradient window applied to at least some of the data samples in the data buffer;
compare the generated moving gradient value to one or more thresholds to detect the start and end of events, the events representing an interaction with the inventory location in which the inventory level changes; and
generate output event data representing the detected event, the output event data at least comprising the weight data representing the inventory level following the detected event for updating the inventory data associated with that inventory location.
